(19) United States
(12) Patent Application Publication
(10) Pub. No.: US 2017/0191468 A1
(43) Pub. Date: Jul. 6, 2017

(54) DEVICE THAT USES GRAVITY TO MOVE WEIGHTS ACROSS A SHAFT ASSEMBLY FOR ROTATION AND TORQUE AND A BRAKING APPARATUS TO REGULATE ROTATION SPEED

(71) Applicant: ANTHONY E. SEQUEIRA, MINE HILL, NJ (US)

(72) Inventor: ANTHONY E. SEQUEIRA, MINE HILL, NJ (US)

(21) Appl. No.: 15/385,775

(22) Filed: Dec. 20, 2016

Related U.S. Application Data
(60) Provisional application No. 62/271,645, filed on Dec. 28, 2015.

(51) Int. Cl. F03G 3/00; F16D 49/16; H02K 7/18; F16D 65/06

(52) U.S. Cl. CPC F03G 3/00; F16D 65/065; F16D 49/16; H02K 7/1807; F03B 17/005

(57) ABSTRACT

A rotation generation device is provided that includes: at least one pair of Cylindrical Containers having Chambers therein at each end to receive and discharge a fluid, the Cylindrical Containers interconnected via a tubular member and mounted essentially perpendicular to a Shaft; Threaded Caps with dual nozzles that screw on to each Chamber at the end of the Cylindrical Containers; two or more Pistons, each Piston interconnected to another Piston via a hollow tube, each Piston resides in a sliding relationship in a respective Cylindrical Container and wherein the hollow tube resides in the tubular member, the hollow tube having a length for a first of the two or more pistons to cause one of the Cylindrical Containers to receive fluid as the first piston slides within the respective Cylindrical Container, while a second of the two or more pistons causes another of the Cylindrical Containers to discharge fluid therein; a weight, residing and capable of moving laterally within the hollow tube; Pipes interconnecting adjacent Cylindrical Containers via the Cap nozzles; bellows within each Chamber of the Cylindrical Containers, wherein each bellow attaches on one end to a Piston and at an opposite end to the Chamber of the Cylindrical Container.

### RELATED APPLICATION

This application claims the benefit of U.S. Provisional Application No. 62/271,645, filed Dec. 28, 2015, which is hereby incorporated herein by reference.

### BACKGROUND

The present application relates to rotation and torque generating devices, and more particularly gravity assisted generation devices.

Rotation generating devices are known, such as those disclosed in U.S. Pat. No. 29,149 to Durham, U.S. Pat. No. 3,034,964 to Diamond, U.S. Pat. No. 3,412,482 to Kusmer, U.S. Pat. No. 6,115,950 to Al-Mutairi, 4,363,212 to Everett, U.S. Pat. No. 5,372,474 to Miller, U.S. Pat. No. 5,944,480 to Forrest, U.S. Pat. No. 5,996,344 to Frenette et. al., U.S. Pat. No. 4,498,294 to Everett, U.S. Pat. No. 6,000,707 to Alkhamis, U.S. Pat. No. 4,254,622 to Denson, Sr, U.S. Pat. No. 4,407,130 to Jackson, U.S. Pat. No. 6,353,270 to Sen, and U.S. Pat. No. 6,764,275 to Carr. These devices, however, have their limitations. Accordingly, there is a need for a novel improvement in this technical field that are not so limited.

### SUMMARY OF THE INVENTION

Generally, the apparatus described in the preferred embodiments, along with the illustrations, provides a unique device which uses gravity to move weights across a shaft assembly for rotation and torque generation, and which is easy to produce, assemble and scale for use in various indoor and outdoor environments.

The present application relates to machine operation that involves gravity pulling down on the liquid filled Chambers, at the end of Oblong Cylindrical Containers attached to a Shaft Assembly, causing partial shaft rotation in its direction. When a liquid filled Chamber drops past horizontal position, it triggers the movement in direction of fall, of a Solid Heavy Density Matter encapsulated in a Piston housed in the Oblong Cylindrical Container, causing more shaft rotation in the same direction. The Piston pumps the liquid in the Chamber, via Nozzles and interconnected Pipes with Screw Caps, to another empty liquid Chamber at a higher elevation. Bellows within the Chambers stop back-flow to other liquid Chambers. As gravity pulls down the newly filled liquid Chambers past horizontal position, it causes the movement of, and pumping action by, the Solid Heavy Density Matter in its Oblong Cylindrical Container, completing a cycle, the repetition of which results in continuous shaft rotations with torque. The pressure of Weights on Brake Pads applied to the Brake Drum reduces spike in rotational speed arising from the rapid descent of a liquid filled Chamber when Solid Density Matter transitions to its side. The reduced rotational speed allows Piston to complete pumping action at the lowest point in rotation and, narrows the variable speed to an acceptable range for grid connectivity. The Horizontal Grooves on Brake Drum reduce braking pressure starting immediately before and ending immediately after a liquid filled Chamber crosses horizontal position.

The efficient machine operation is dependent on one or more of the following: (a) that relative to the Shafts longitudinal axis, the total weight on the side with liquid filled Chambers, should be kept greater than the total weight on the opposite side, thereby causing the Oblong Cylindrical Containers and Shaft Assembly to spin continuously in the direction of the greater total weight, (b) that relative to the Shaft Assembly, Heavy Density Matter transitions to a position below the Shafts Assembly's height, thereby ensuring the portion of an Oblong Cylindrical Container in the upper quadrant opposite filled Chambers, does not include the Solid Heavy Density Matter (c) to eliminate or minimize any backward spin against the direction of rotation in the lower quadrant opposite filled Chambers, by having the pumping action completed at the lowest point in rotation using the Braking Apparatus to slow the rotational speed d) using interconnected Pipes with appropriate diameter in order to avoid excessive or low outflows (e) that the weight of liquid inserted into a Chamber is greater than the combined weights of Solid Heavy Density Matter and Solid Light Weight Matter in the Piston of the Oblong Cylindrical Container and, provides enough torque for operation of the generator (f) that Horizontal Grooves on Brake Drum are placed so as to reduce braking pressure starting immediately before and ending immediately after a liquid filled Chamber crosses horizontal position and (g) that optimum torque and performance of this device, for use with a specific generator and gearbox, can be achieved by scaling either up or down one or more constituent parts.

In one embodiment, the application provides a unique gravity or kinetic driven machine of the type which comprises a plurality of Stands anchored by Weighted Ground Stakes, that support a configured Shaft Assembly, a plurality of Oblong Cylindrical Containers mounted perpendicular to the machine's Shaft Assembly, each Oblong Cylindrical Container consisting of Chambers for holding liquid matter, Caps with threaded dual Nozzles and Bellows with screws, at both ends, each Oblong Cylindrical Container encasing a Piston mechanism operated by encapsulated Solid Heavy Density Matter, the liquid Chambers interconnected by Pipes with Screw Caps, and a Braking Apparatus to regulate variable rotational speeds.

In one embodiment, gravitational force of a falling liquid-filled Chamber is used to cause the movement, in its direction, of the Solid Heavy Density Matter across the length of the Oblong Cylindrical Container, forcing the Piston to pump liquid from the Chamber of the Oblong Cylindrical Container via interconnected Pipes with Screw Caps, to the empty Chamber of another connected Oblong Cylindrical Container at a higher elevation.

In one embodiment, the total combined weight of all matter on the side of the Shaft Assembly's longitudinal axis having the plurality of filled-liquid Chambers of Oblong Cylindrical Containers, should be greater than opposite side by using a combination of (a) the movement, and resulting gravitational or kinetic energy from movement of, Solid Heavy Density Matter across Oblong Cylindrical Containers (b) the gravitational or kinetic energy from the downward fall of a plurality of filled-liquid Chambers in Oblong Cylindrical Containers and (c) the pumping of liquid from a filled Chamber in an Oblong Cylindrical Container to an empty chamber, at higher elevation, of another Oblong Cylindrical Container, on the same side as the filled Chamber.

In one embodiment, use of the gravitational or kinetic energy resulting from the downward pull of a filled liquid Chamber in an Oblong Cylindrical Container, in combination with the shifting weights and pumping action of Piston in the Oblong Cylindrical Container, causes a continuous rotational action along the longitudinal axis of the Shaft Assembly, in the direction of each moving Solid Heavy Density Matter, towards the side with the filled liquid Chamber of an Oblong Cylindrical Container, resulting in production of mechanical energy for torque and speed.

In one embodiment, use, as an option, on either side of the Solid Heavy Density Matter in a Piston in an Oblong Cylindrical Container, of a Solid Light Weight Matter called “Stoppers”, based on Newton's Laws on Mass and Rotational Matter, will increase the torque and rotational speed applied to the Shaft Assembly as a whole, in the direction of the side having the filled liquid Chambers in an Oblong Cylindrical Container.

In one embodiment, the machine's Shaft Assembly is configured to consist of (a) Clamps on either side of an Oblong Cylindrical Container to hold it in a sandwich vice-like grip and bolted together, through Panels of length equal to the mid-section of Oblong Cylindrical Container, causing a tight box grip around the mid-section of the Oblong Cylindrical Containers (b) each Clamp having on side facing away from the Oblong Cylindrical Containers, a small portion of Shaft or extension with a square, or hexagonal, female socket at end, to accept the square, or hexagonal, male head of Shaft Bit (c) Shaft Bit with square, or hexagonal, male heads at both ends used to join Clamps of two Oblong Cylindrical Containers (d) Shaft Enders having a larger diameter center Brake Drum with Horizontal Grooves to reduce braking pressure starting immediately before and ending immediately after a liquid filled Chamber crosses horizontal position, and with square or hexagonal male heads at both ends, one end connecting Clamp of Oblong Cylindrical Container and other end acting as output to gear box that feeds an electric generator, or to connect another set of Oblong Cylindrical Containers to form a series to enhance the torque and speed applied to the Shaft Assembly as a whole.

In one embodiment, use one or more Braking Apparatus to slow the rotational speed of the Shaft Assembly so that: (a) the pumping action in an Oblong Cylindrical Container is completed at the lowest point in rotation and (b) to narrow the range of variable speeds for grid connectivity. The Braking Apparatus consisting of a Pedestal with Angular Tube, a Brake Pedal attached to Brake Pads and a Ringed Rod to hold Weights. One or more embodiments of the apparatus discussed herein, allows enhanced performance or scaling of this machine by configuring variables namely:

(a) The physical size of the machine as a whole.

(b) Dimensions and material composition of the Oblong Cylindrical Containers, including length of mid-section and Pistons, volume of liquid Chambers, diameter of Nozzles, Pipes and Bellows.

(c) Quantity, dimension, mass and material composition of Solid Heavy Density Matter and Stoppers used in Pistons.

(d) Quantity and material composition of liquid used in Chambers.

(e) Dimension, mass and material composition of Clamps, Shaft Enders or Shaft Bits including fabricated as combined parts.

(f) Dimension, mass and material composition of Braking Apparatus including fabricated as combined parts.

(g) Using a number of Oblong Cylindrical Containers, or the machine as a whole, in a series.

(h) Use of generic commonly known gear boxes and generators at one or both open ends of Shaft Assembly.

Changing any one or all of the parts relative to the dimension, shape, number, content, composition and position alters the ultimate performance of the machine, but does not alter the underlying unique process, concept and methodology of this invention as a gravity driven machine for generating power.

In certain embodiments, the device operates by using gravity to move one or more Solid Heavy Density Matter or weights, across a Shaft Assembly for rotation and torque, the said Solid Heavy Density Matter housed within a respective Piston, the said Piston housed within a respective Oblong Cylindrical Container, the said Oblong Cylindrical Containers having Chambers at each end to either receive or discharge water to a Chamber in an adjacent Oblong Cylindrical Container, each Chamber having a Bellow within to stop backflow of the water, the device comprising two or more Oblong Cylindrical containers interconnected by Pipes; the Oblong Cylindrical Containers mounted in pairs, each Oblong Cylindrical Containers at 90 degree angles to the other in the pair, on a Shaft Assembly that enables rotation of the Oblong Cylindrical Containers; the Shaft Assembly mounted on a supporting structure. The continuous drop of a liquid-filled Chamber, downward displacement of Solid Heavy Density Matter in Pistons, transfer of water from the said liquid-filled Chamber to an adjacent Chamber in a higher quadrant on the same side, causes the continuous rotation of the Shaft which comprises an assembly of: Clamps that hold one or more pairs of the Oblong Cylindrical Containers, Shaft Bits, and Shaft Enders with a larger diameter center Brake Drum with Horizontal Grooves, the Shaft Enders connected to a gearbox coupled to a generator for producing electricity. A Braking Apparatus, mounted on the supporting Stands, regulates the rotation speed for electricity production and grid connectivity.

In one embodiment, a process, concept and method of rotating a Shaft Assembly is provided, which holds a pair, or series of pairs, of Oblong Cylindrical Containers, and its constituent parts, interconnected by hollow Pipes, the Shaft Assembly mounted on Stands with a Braking Apparatus and wherein: Liquid positioned in an upper quadrant Chamber of an Oblong Cylindrical Container, causes it to drop, as a result of gravity, to a point below horizontal, imparting a spin on the Shaft Assembly; The Solid Heavy Density Matter enclosed in the Piston and the said Piston enclosed in the respective Oblong Cylindrical Container, moves across the Shaft Assembly, as a result of gravity, to the opposite side when the liquid-filled Chamber drops below horizontal, thereby imparting further spin on the Shaft Assembly in the same direction; The Solid Heavy Density Matter enclosed in the Piston and the said Piston forces the liquid in the said dropping Chamber of respective Oblong Cylindrical Container, to an upper quadrant Chamber, on the same side, in an adjacent Oblong Cylindrical Container in the pair, wherein the transfer of liquid between Chambers is via the interconnected Pipes; The transfer of liquid from a lower Chamber to an upper quadrant Chamber in the adjacent Oblong Cylindrical Container causes the upper quadrant Chamber to drop, as a result of gravity, to a point below horizontal, imparting further spin on the Shaft Assembly, in the same direction, and inducing the Solid Heavy Density Matter enclosed in the Piston and the said Piston in the respective Oblong Cylindrical Container, to move across the Shaft Assembly, as a result of gravity, to the opposite side thereby forcing the transfer of liquid from the said dropping Chamber to an upper quadrant Chamber of an adjacent Oblong Cylindrical Container in the pair, on the same side, wherein the transfer of liquid between Chambers is via the interconnected Pipes; The continuous rotation of Shaft Assembly is achieved by a continuous sequence of:

a) Gravity causing a liquid filled Chamber of a respective Oblong Cylindrical Container to drop below horizontal;

b) Which causes gravity to move the Solid Heavy Density Matter and the Piston to the opposite side of the said Oblong Cylindrical Container;

c) The said Solid Heavy Density Matter and the Piston, forcing out the liquid from the dropped Chamber to an upper quadrant Chamber, on the same side, in an adjacent Oblong Cylindrical Container in the pair.

In one embodiment, a process, concept and method of claim is provided wherein the rotational speed of the Shaft Assembly is regulated by a Braking Apparatus that applies braking pressure on respective Brake Drum, on a Shaft Ender, the Braking Apparatus comprising: a Pedestal, a Ringed Rod, a Brake Pedal, a Brake Pad and a weight with a center hole that sits on the Ringed Rod;

In one embodiment, a process, concept and method of claim is provided including the use of Oblong Cylindrical Container with Liquid Chambers at both ends each Chamber having threaded Caps with dual nozzles and inside Washers with eyelets and holes at bottom of Chambers to accept lower screws of Bellow.

In one embodiment, a process, concept and method of claim is provided including the use of the Piston comprising a hollow tube to accept a Solid Heavy Solid Heavy Density Matter and Cap-Heads with holes to accept the upper screws of Bellow.

In one embodiment, a process, concept and method of claim is provided including the optional use of Light Weight Matter on each side of the Solid Heavy Density Matter in the Piston, for the purpose of setting the stop-position of the Solid Heavy Density Matter in the Piston.

In one embodiment, a process, concept and method of claim is provided including the use of the Bellows with lower screws that attach to the bottom of respective Chamber, and upper screws that attach to the Piston Cap-Head.

In one embodiment, a process, concept and method of claim is provided including the use of the rotatable Shaft Assembly that holds Oblong Cylindrical Container perpendicular to the Shaft Assembly, with Clamps, Panels and Bolts in a box like grip.

In one embodiment, a process, concept and method of claim is provided including the use of Series Clamp with a square female socket moved 45 degrees, to make a transitional connection in a series of pairs of Oblong Cylindrical Containers held perpendicular to the Shaft Assembly, with Clamps, Panels and Bolts in a box like grip;

In one embodiment, a process, concept and method of claim is provided including the use of Shaft Bits to connect Clamps at 90 degrees to an each other, in the rotatable Shaft Assembly, and for the purpose of easy production, transportation and assembly;

In one embodiment, a process, concept and method of claim is provided including the use of Shaft Enders with a larger diameter center Brake Drum having Horizontal Grooves and Radial Bearing Rings and male heads at both ends to connect either to a Clamp or to a Gear wheel of a gearbox and for the purpose of easy production, transportation and assembly;

In one embodiment, a process, concept and method of claim is provided including the use of Brake Drum having Horizontal Grooves so as to reduce braking pressure starting immediately before and ending immediately after a liquid filled Chamber crosses horizontal position.

In one embodiment, a process, concept and method of claim is provided including the use of Radial Bearing Rings held within brackets that mount on respective Stand, the Radial Bearing Rings to enable smooth rotation of the Shaft Assembly;

In one embodiment, a process, concept and method of claim is provided including the use of Stands to accommodate the Shaft Assembly and the Braking Apparatus.

In one embodiment, a process, concept and method of claim is provided including the continuous downward displacement of Solid Heavy Density Matter in Pistons and displacement of water in Chamber of Oblong Cylindrical Container causes the continuous rotation of the Shaft Assembly coupled to a gearbox that is coupled to a generator for producing electricity.

In one embodiment, a process, concept and method of claim is provided including relative to the Shafts Assembly's longitudinal axis, the total weight on the side with liquid filled Chambers, is always kept greater than the total weight on the opposite side, thereby causing the Oblong Cylindrical Containers and Shaft Assembly to spin continuously in the direction of the greater total weight; relative to the Shaft Assembly, Solid Heavy Density Matter transitions to a position below the Shafts Assembly's height, thereby ensuring the portion of an Oblong Cylindrical Container in the upper quadrant opposite filled Chambers, does not include the Solid Heavy Density Matter; to eliminate or minimize any backward spin against the direction of rotation in the lower quadrant opposite filled Chambers, by having the pumping action completed at the lowest point in rotation using a Braking Apparatus to slow the rotational speed interconnected Pipes with appropriate diameter is used in order to avoid excessive or low outflows; the weight of liquid inserted into a Chamber is greater than the combined weights of Solid Heavy Density Matter and Solid Light Weight Matter in the Piston of the Oblong Cylindrical Container and, provides enough torque for operation of the generator Horizontal Grooves on Brake Drum are placed so as to reduce braking pressure starting immediately before and ending immediately after a liquid filled Chamber crosses horizontal position and; optimum torque and performance can be achieved by scaling either up or down one or more constituent parts of this gravity powered device, in relation to a specific generator output for producing electricity.

In one embodiment, a rotation generation device is provided that includes: at least one pair of Cylindrical Containers having Chambers therein at each end to receive and discharge a fluid, the Cylindrical Containers interconnected via a tubular member and mounted essentially perpendicular to a Shaft; Threaded Caps with dual nozzles that screw on to each Chamber at the end of the Cylindrical Containers; two or more Pistons, each Piston interconnected to another Piston via a hollow tube, each Piston resides in a sliding relationship in a respective Cylindrical Container and wherein the hollow tube resides in the tubular member, the hollow tube having a length for a first of the two or more pistons to cause one of the Cylindrical Containers to receive fluid as the first piston slides within the respective Cylindrical Container, while a second of the two or more pistons causes another of the Cylindrical Containers to discharge fluid therein; a weight, residing and capable of moving laterally within the hollow tube; Pipes interconnecting adjacent Cylindrical Containers via the Cap nozzles; bellows within each Chamber of the Cylindrical Containers, wherein each bellow attaches on one end to a Piston and at an opposite end to the Chamber of the Cylindrical Container.

In one embodiment, the device includes at least two pair of Cylindrical Containers having Chambers therein at each end to receive and discharge a fluid, each pair of Cylindrical Containers interconnected via a tubular member, a first pair of Cylindrical Containers assembled on the shaft to be offset at about 90 degrees from a second pair of Cylindrical Containers.

In one embodiment, the device includes a Braking Apparatus for applying braking pressure to reduce rotational speed of the Shaft,

In one embodiment, each Braking Apparatus comprises: a Pedestal, a Ringed Rod, a Brake Pedal, a Brake Pad and a weight with a center hole that sits on the Ringed Rod.

In one embodiment, the fluid is a liquid.

In one embodiment, the length of the hollow tube equals: a length of one Chamber, plus a length of the tubular members interconnecting Chambers, plus a thickness of the Pistons.

In one embodiment, the device includes a Shaft Assembly that enables rotation of the Cylindrical Containers and which is connected to a gearbox coupled to a generator for producing electricity, including Clamps with female sockets and Panels coupled together on either side, so as to hold the Cylindrical Containers perpendicular to the Shaft; Shaft Bits with male heads that connect to Clamps with female sockets; Shaft Enders with male heads, the Shaft Enders having Radial Bearing Rings at both ends and a larger diameter center Brake Drum with Horizontal Grooves, the Radial Bearing Rings held within Brackets that can be attached to and supported by Stands.

In one embodiment, the Bellows prevent backflow of liquid to another Chamber of a Cylindrical Container.

In one embodiment, the device includes an arrangement of Cylindrical Containers in a series of pairs, wherein each pair of Cylindrical Container is clamped to the Shaft so as to be perpendicular to the Shaft Assembly and 45 degrees to another pair of Cylindrical Containers clamped on the Shaft.

In one embodiment, the device includes two pairs of Hollow Pipes angled inwards at ends and with screw caps at ends, for each pair of Cylindrical Containers; wherein each Hollow Pipe has one end connected to a Chamber Cap Nozzle of an Cylindrical Container and the other end connected to a Chamber Cap nozzle of an adjacent Cylindrical Container in the pair; the connected Pipes being in a square-like form wherein the pair of Hollow Pipes from a Chamber Cap's dual nozzles do not connect into the same Chamber Cap's dual nozzles of an adjacent Cylindrical Container in the pair.

In one embodiment, the device includes a quantity of liquid, preferably water, positioned in an upper quadrant Chamber of a Cylindrical Container, that provides enough torque to operate a generator and wherein: the upper quadrant Chamber of the Cylindrical Container is the one initiating the direction of Shaft's spin.

In one embodiment, the device includes: at least two pair of Cylindrical Containers having Chambers therein at each end to receive and discharge a fluid, each pair of Cylindrical Containers interconnected via a tubular member and mounted essentially perpendicular to a Shaft; Threaded Caps with dual nozzles that screw on to each Chamber at the end of the Cylindrical Containers; two pair of Pistons, each pair of Pistons interconnected via a hollow tube, each pair of Pistons resides in a sliding relationship in a respective pair of Cylindrical Containers and wherein the hollow tube interconnecting the pair of Pistons resides in the tubular member of the respective pair of Cylindrical Containers, the hollow tubes having a length for a first of the pair of pistons to cause one of the Cylindrical Containers to receive fluid as the first piston slides within the respective Cylindrical Container, while a second of the pair pistons causes another of the Cylindrical Containers to discharge fluid therein; a weight, residing and capable of moving laterally within each of the hollow tubes; Pipes interconnecting adjacent Cylindrical Containers via the Cap nozzles; Bellows within each Chamber of the Cylindrical Containers, wherein each bellow attaches on one end to a Piston and at an opposite end to the Chamber of the Cylindrical Container to prevent backflow of fluid to another Chamber of a Cylindrical Container.

Accordingly, the design, functioning and operation of the device and constituent parts, which as a whole make up this invention detailed above, are derivatives resulting from the unique process, concept and methodology of this gravity driven machine for generating power. Changing any one, or all of the parts relative to the dimension, shape, number, content, composition and position will alter the ultimate performance of the machine, but does not alter the underlying unique process, concept and methodology of this invention of a gravity driven machine for generating power.

Additional aspects of the present invention will be apparent in view of the description which follows.

### BRIEF DESCRIPTION OF THE FIGURES

FIG. 1 shows a perspective side view and partial cross section of the gravity driven machine according to at least one embodiment, using two Oblong Cylindrical Containers.

FIG. 2 shows the front view of an assembled machine, relative to FIG. 1, consisting of Stands with Weighted Ground Stakes, Shaft Assembly configuration comprising Clamps holding two Oblong Cylindrical Containers with interconnected Pipes, Shaft Bit connecting Clamps of two Oblong Cylindrical Containers, and Shaft Enders, with Brake Drum, one end connecting Clamp of Oblong Cylindrical Container and other end acting as output to gear box that feeds an electric generator, or to connect another set of Oblong Cylindrical Containers to form a series as shown in FIG. 15, and Braking Apparatus as described in FIG. 11 and FIG. 12.

FIG. 3 shows separately the side and front view of the Stands with Weighted Ground Stakes, relative to FIG. 1 and FIG. 2.

FIG. 4 shows the cross section of an Oblong Cylindrical Container with holes at base of each liquid Chamber to attach one end of a Bellow, as shown in FIG. 1, the Oblong Cylindrical Container Caps with threaded dual Nozzles, one Cap showing a cross section with inside Washer.

FIG. 5 shows the cross section of Piston, with Cap-Heads having holes to attach one end of a Bellow, as shown in FIG. 1

FIG. 6 shows a Bellow with upper screw heads that attach to Piston Cap-Head as in FIG. 1, and relative to FIG. 5, and lower screw heads that connect to base of liquid Chamber of an Oblong Cylindrical Container, as shown in FIG. 1 and relative to FIG. 4.

FIG. 7 shows separately side and front view of a Clamp with square female socket, relative to FIG. 1 and FIG. 2, a pair of which is used to hold in a sandwich grip an Oblong Cylindrical Container perpendicular to the Shaft Assembly as a whole, the Clamp being part of the Shaft Assembly.

FIG. 8 shows separately front and side view of a Panel, used on opposite sides of an Oblong Cylindrical Container, each bolted to Clamps on either side, so as to hold in a box grip an Oblong Cylindrical Container perpendicular to the Shaft Assembly as a whole, as shown in FIG. 1 and FIG. 2.

FIG. 9 shows a Shaft Bit with square male heads at both ends, the Shaft Bit used to connect Clamps, as shown in FIG. 2.

FIG. 10 shows a front view of Shaft Ender with a larger diameter center Brake Drum having Horizontal Grooves to reduce brake pressure, Radial Bearing Rings and male heads at both ends.

FIG. 11 shows (a) side view and cross section of Braking Apparatus consisting of a Pedestal with Angular Tube, a Brake Pedal attached to Brake Pad, a Ringed Rod and a Weight. (b) side view for top of Stand and Brackets supporting the Radial Bearing Rings of the Shaft Ender and (c) side view of Shaft Ender with Brake Drum having Horizontal Grooves to reduce braking pressure starting immediately before and ending immediately after a liquid filled Chamber crosses horizontal position.

FIG. 12 shows aerial view (a) Braking Apparatus as described in FIG. 11: Pedestal, Ringed Rod, Brake Pedal and Brake Pad (b) Shaft Ender as described in FIG. 10: Brake Drum, Horizontal Grooves and male heads (c) Brackets, as described in FIG. 11, mounted on Stands anchored with Weighted Ground Stakes.

FIG. 13 shows side view of a Series Clamp with square female socket moved 45 degrees relative to side view of Clamp in FIG. 7, the Series Clamp used to make a transitional connection in a series, shown in FIG. 14 and FIG. 15.

FIG. 14 shows a side view of four Oblong Cylindrical Containers connected in a series consisting of two sets of Oblong Cylindrical Containers each set with Oblong Cylindrical Containers at 90 degrees to the other as shown in FIG. 1 and FIG. 2, and the two sets connected at 45 degrees using one Series Clamp FIG. 13.

FIG. 15 shows a front view of an assembled machine, relative to FIG. 2, connected in a series of four Oblong Cylindrical Containers as shown in FIG. 14, Stands with Weighted Ground Stakes, Shaft Assembly showing Shaft Bit, Series Clamp and Shaft Enders, with Brake Drum, one end connecting Clamp of Oblong Cylindrical Container and other end acting as output to gear box that feeds an electric generator, Braking Apparatus as described in FIG. 11 and FIG. 12.

### DETAILED DESCRIPTION

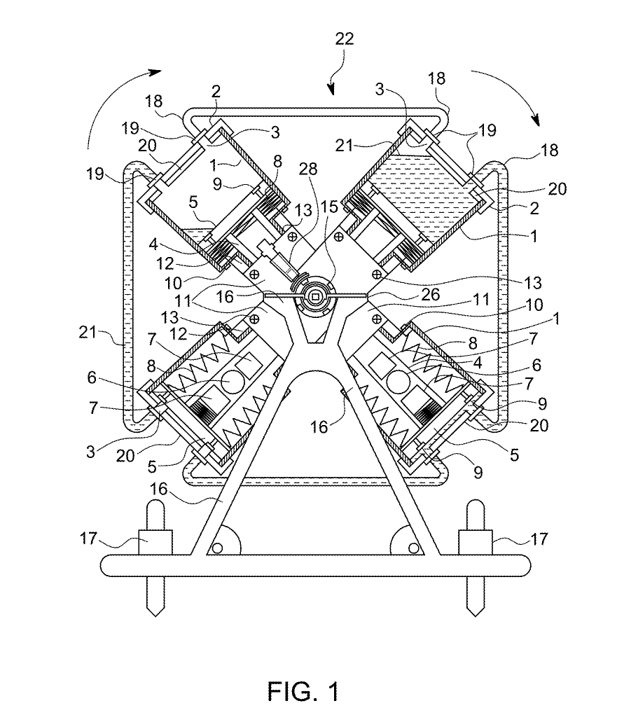

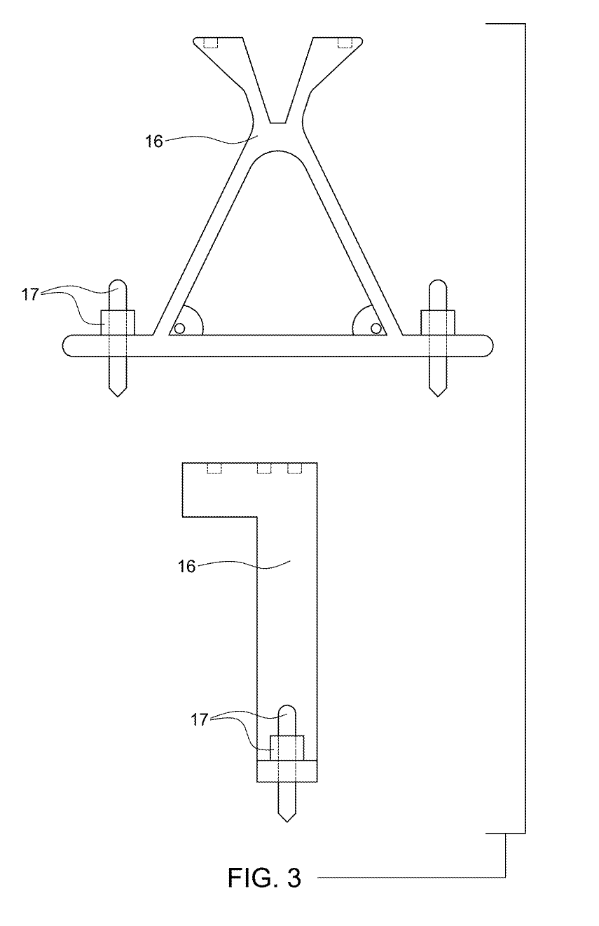

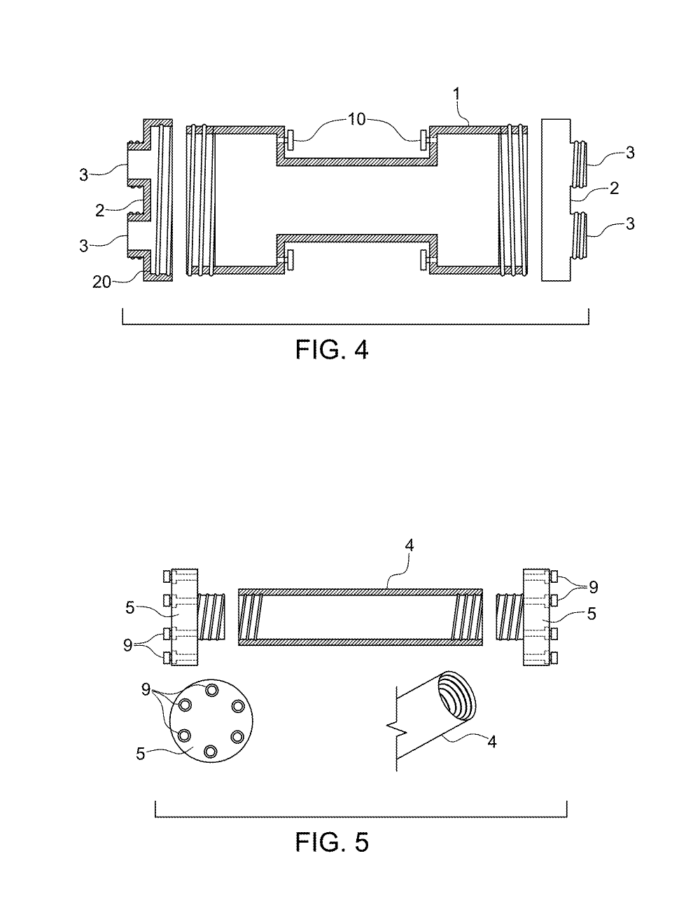

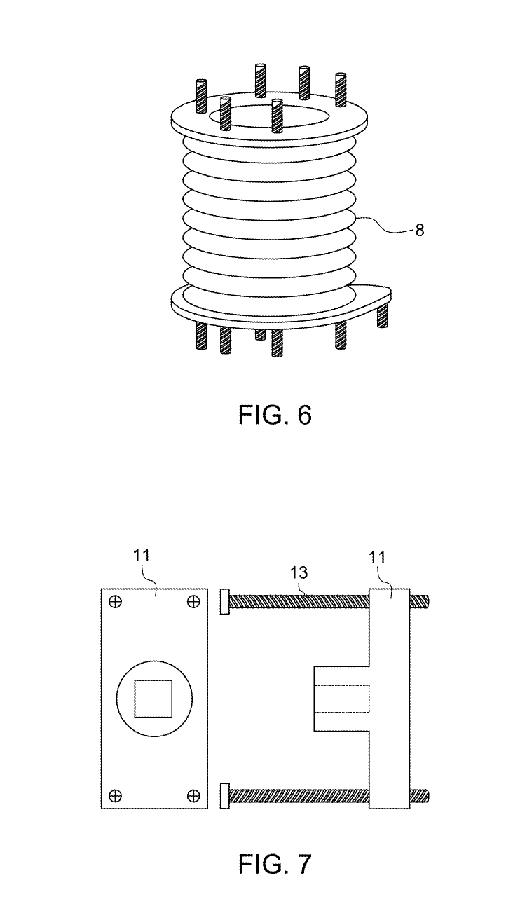

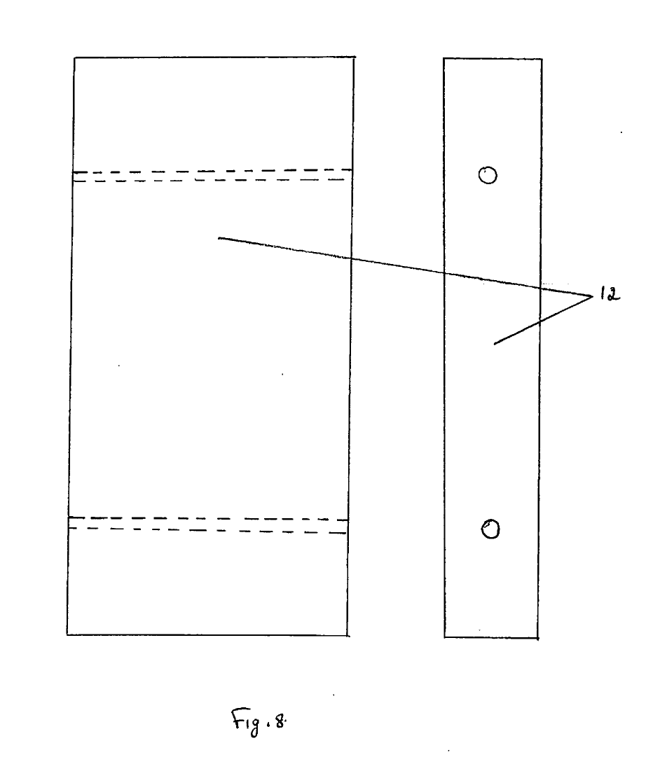

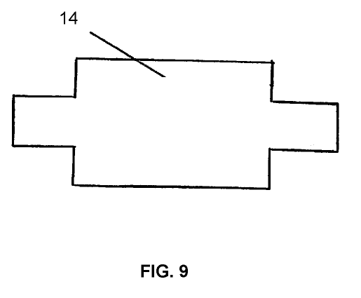

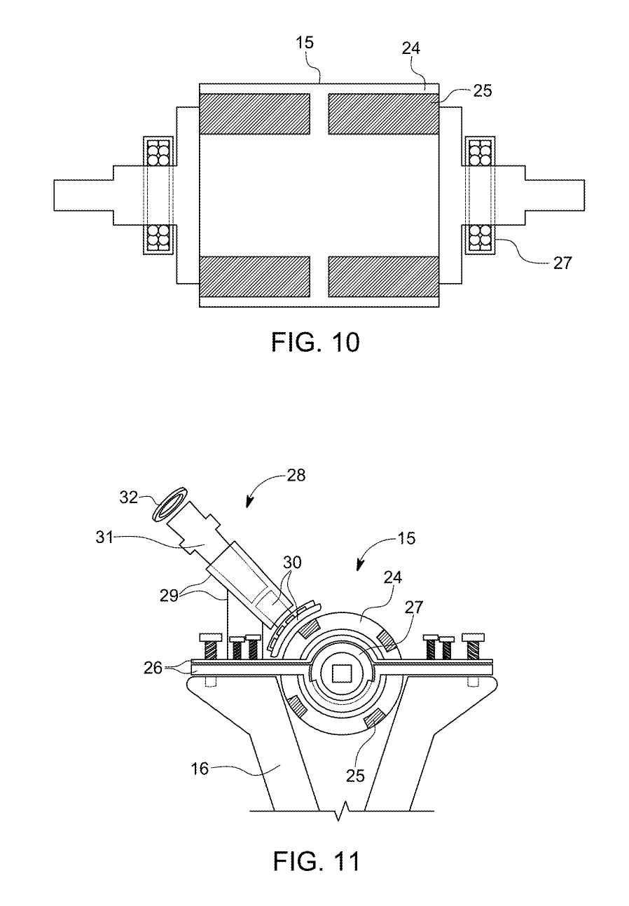

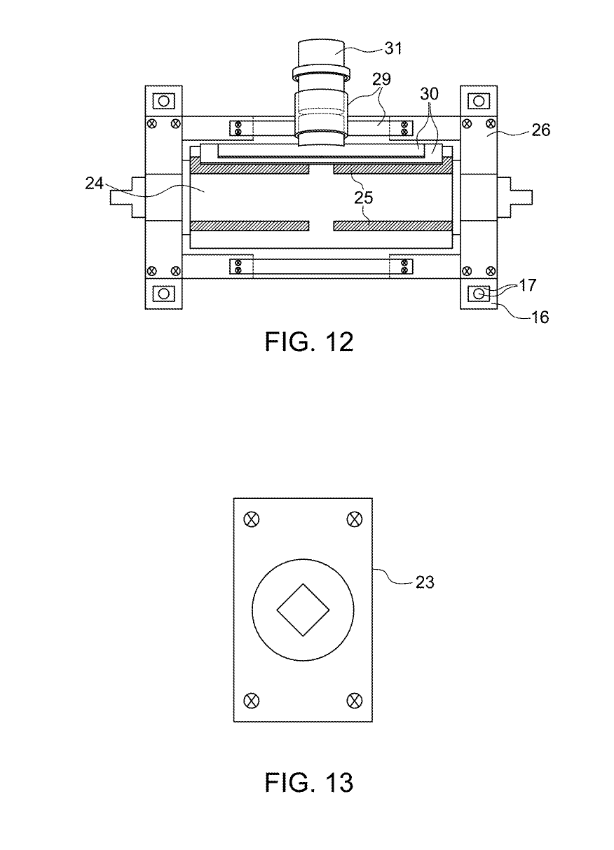

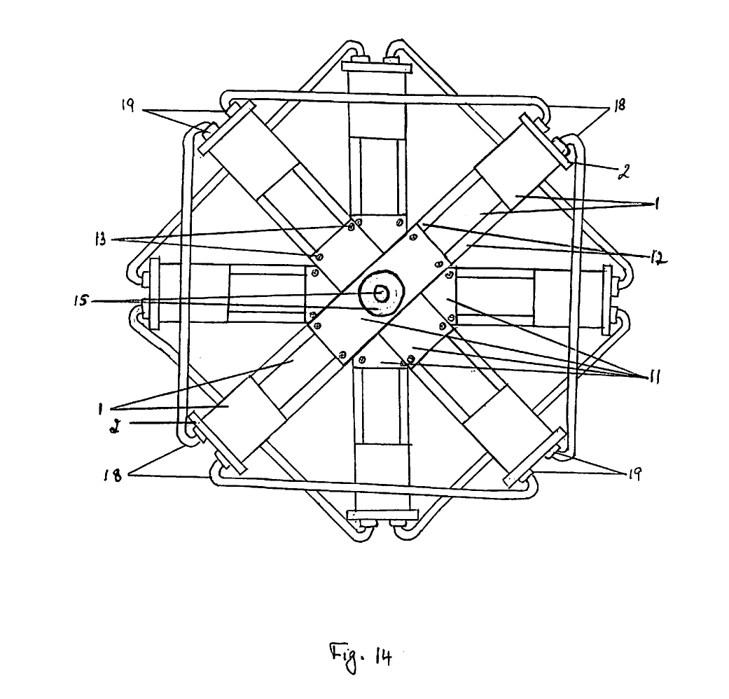

This application describes a device that uses gravity to move weights across a configured Shaft Assembly for generating rotation and torque, the speed regulated by a gravity driven braking mechanism, is described herein, together with the drawings and illustrations in FIG. 1 to FIG. 15 and described generally by the reference numeral 22.

In a preferred embodiment, the device 22 includes one or preferably a plurality of Oblong Cylindrical Containers 1 having narrow mid-section and larger liquid Chambers at each of the two ends, each Chamber with Caps 2 having threaded dual Nozzles 3. Each Oblong Cylindrical Container 1 encases a Piston comprising a tube 4 of length equal to the mid-section of the Oblong Cylindrical Container 1 plus height of a collapsed Bellow 8, with Cap-Heads 5 at both ends. Within each Piston may be a Solid Heavy Density Matter 6 or other Matter and having optional two blocks of Solid Light Weight Matter called “Stoppers” 7 on either side of the Solid Heavy Density Matter 6. Within each Oblong Cylindrical Container's 1 Chamber is a Bellow 8 which may be attached with head and tail screws or any other manner, with the head screws attached to the head of a Piston Cap 5 using embedded Nuts 9, and the tail screws attached to the Oblong Cylindrical Container's 1 Chamber base using Nuts 10.

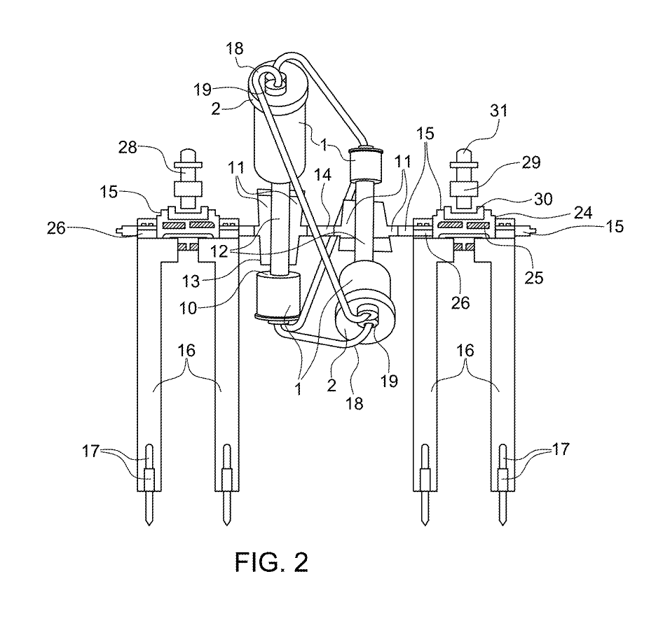

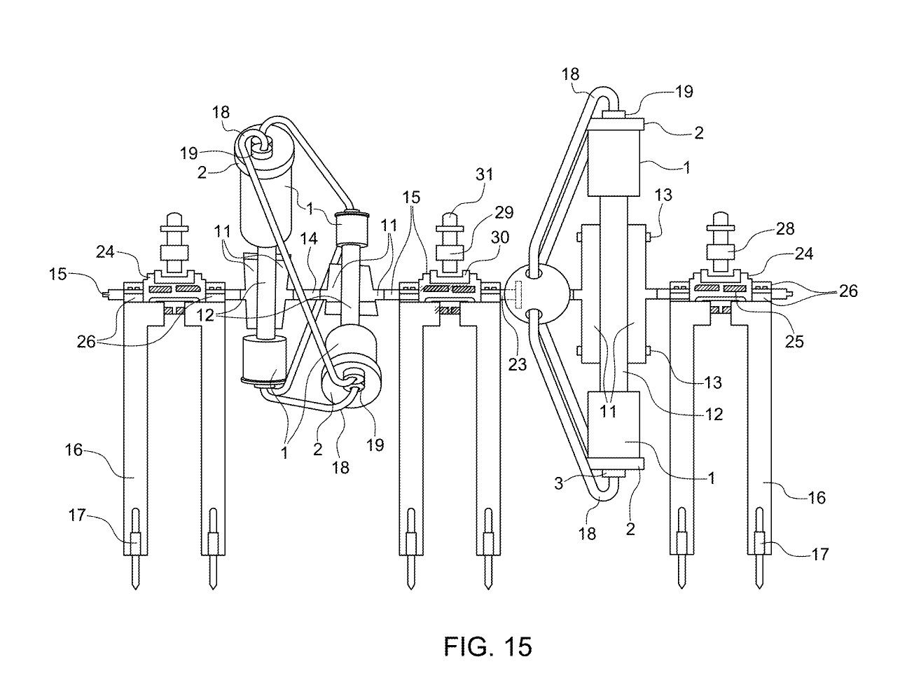

The Oblong Cylindrical Containers 1 attach to a configured Shaft Assembly as shown in FIG. 2, comprising Clamps with female socket 11 to provide a sandwich-like grip, the Clamps 11 attached with Bolts 13 to side Panels 12 to form a box grip around each Oblong Cylindrical Containers 1. A Shaft Bit 14, having male heads on each side of the Shaft Bit 14 connects the Clamps 11 of adjacent Oblong Cylindrical Containers 1. Shaft Enders generally described by the reference numeral 15 with Brake Drum 24 having Horizontal Grooves 25 and male heads at each side that connect to a female end of Clamp 11 on one side of the Shaft Enders 15, and other side of the Shaft Enders 15 connecting either to a gear box not shown, or, to a Series Clamp 23 having female socket turned 45 degrees compared to the main Clamp 11, to form a series of Oblong Cylindrical Containers 1, as shown in FIG. 15. The configured Shaft Assembly comprising 11, 12 (Tubular Member), 13, 14 (Shaft), 15 and including Oblong Cylindrical Containers 1 may be mounted on Stands 16 or any other foundation, with Brackets 26 encasing Radial Bearing Rings 27 on both sides of the device. The Stand 16 anchored by Weighted Ground Stakes 17.

The Oblong Cylindrical Containers 1 interconnected by Pipes having, e.g., 135 degree, elbows 18 and Screw Caps 19 at both ends, which attach to the threaded Nozzles 3 of the Oblong Cylindrical Container Caps 2, each Oblong Cylindrical Container Cap 2 having an inside washer 20.

A Braking Apparatus, generally described by the reference numeral 28 includes a Pedestal with Angular Tube 29, a Brake Pedal with Brake Pad 30, a Ringed Rod 31 and a Weight 32, is mounted on Stand 16 or any other manner with the Brake Pad 30 against Brake Drum 24. The Weight 32 applying just enough braking pressure to slow down rotational speed and enable Piston 5 to complete pumping action at the lowest point in rotation. The Horizontal Grooves 25, on Brake Drum 24, serving to reduce braking pressure starting immediately before and ending immediately after a liquid filled Chamber crosses horizontal position.

A quantity of liquid 21, preferably water or other liquid is filled into parts of the device in a sequence comprising (a) Via Nozzles 3, filling Pipes 18 that fully or partly connect to chambers below the shaft height via Screw Caps 19, as shown in FIG. 1 (b) leaving empty any Pipe 18 that fully connects to chambers above the shaft height, as shown in FIG. 1, and (c) filling a Chamber of an Oblong Cylindrical Container 1, in the upper quadrant on the side of desired direction of rotation, as shown in FIG. 1, the weight of liquid being greater than the combined weights of Solid Heavy Density Matter and Solid Light Weight Matter in the Piston of the Oblong Cylindrical Container and, provides enough torque to cause rotation in the Oblong Cylindrical Containers 1 for operation of, e.g., the generator.

Machine operation involves gravity pulling down on the liquid filled Chambers, at the end of Oblong Cylindrical Containers attached to a Shaft Assembly, causing partial shaft rotation in its direction. When a liquid filled Chamber drops past horizontal position, it triggers the movement in direction of fall, of a Solid Heavy Density Matter encapsulated in a Piston housed in the Oblong Cylindrical Container, causing more shaft rotation in the same direction. The Piston pumps the liquid in the Chamber, via Nozzles and interconnected Pipes with Screw Caps, to another empty liquid Chamber at a higher elevation. Bellows within the Chambers stop back-flow to other liquid Chambers. As gravity pulls down the newly filled liquid Chambers past horizontal position, it causes the movement of, and pumping action by, the Solid Heavy Density Matter in its Oblong Cylindrical Container, completing a cycle, the repetition of which results in continuous shaft rotations with torque. The pressure of Weights on Brake Pads applied to the Brake Drum reduces spike in rotational speed arising from the rapid descent of a liquid filled Chamber when Solid Density Matter transitions to its side. The reduced rotational speed (a) allows Piston to complete pumping action at the lowest point in rotation and (b) narrows the variable speed to an acceptable range for grid connectivity. The Horizontal Grooves on Brake Drum reduce braking pressure starting immediately before and ending immediately after a liquid filled Chamber crosses horizontal position.

The efficient machine operation is dependent on one or more of the following: (a) that relative to the Shafts longitudinal axis, the total weight on the side with liquid filled Chambers, should be kept greater than the total weight on the opposite side, thereby causing the Oblong Cylindrical Containers and Shaft Assembly to spin continuously in the direction of the greater total weight, (b) that relative to the Shaft Assembly, Heavy Density Matter transitions to a position below the Shafts Assembly's height, thereby ensuring the portion of an Oblong Cylindrical Container in the upper quadrant opposite filled Chambers, does not include the Solid Heavy Density Matter (c) to eliminate or minimize any backward spin against the direction of rotation in the lower quadrant opposite filled Chambers, by having the pumping action completed at the lowest point in rotation using the Braking Apparatus to slow the rotational speed d) using interconnected Pipes with appropriate diameter in order to avoid excessive or low outflows (e) that the weight of liquid inserted into a Chamber is greater than the combined weights of Solid Heavy Density Matter and Solid Light Weight Matter in the Piston of the Oblong Cylindrical Container and, provides enough torque for operation of the generator (f) that Horizontal Grooves on Brake Drum are placed so as to reduce braking pressure starting immediately before and ending immediately after a liquid filled Chamber crosses horizontal position and (g) that optimum torque and performance of this device, for use with a specific generator and gearbox, can be achieved by scaling either up or down one or more constituent parts.

It is worth noting that design, functioning and operation of the device and constituent parts, which as a whole make up this invention detailed above, including illustrations FIG. 1 to FIG. 15, are derivatives resulting from the unique process, concept and methodology of this gravity driven machine for generating power. Changing any one, or all of the parts relative to the dimension, shape, number, content, composition and position will alter the ultimate performance of the machine, but does not alter the underlying unique process, concept and methodology of this invention of a gravity driven machine for generating power.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A rotation generation device comprising:
at least one pair of Cylindrical Containers having Chambers therein at each end to receive and discharge a fluid, the Cylindrical Containers interconnected via a tubular member and mounted essentially perpendicular to a Shaft;
Threaded Caps with dual nozzles that screw on to each Chamber at the end of the Cylindrical Containers;
two or more Pistons, each Piston interconnected to another Piston via a hollow tube, each Piston resides in a sliding relationship in a respective Cylindrical Container and wherein the hollow tube resides in the tubular member, the hollow tube having a length for a first of the two or more pistons to cause one of the Cylindrical Containers to receive fluid as the first piston slides within the respective Cylindrical Container, while a second of the two or more pistons causes another of the Cylindrical Containers to discharge fluid therein;
a weight, residing and capable of moving laterally within the hollow tube;
Pipes interconnecting adjacent Cylindrical Containers via the Cap nozzles;
bellows within each Chamber of the Cylindrical Containers, wherein each bellow attaches on one end to a Piston and at an opposite end to the Chamber of the Cylindrical Container.

2. The rotation generation device of claim 1, comprising at least two pair of Cylindrical Containers having Chambers therein at each end to receive and discharge a fluid, each pair of Cylindrical Containers interconnected via a tubular member, a first pair of Cylindrical Containers assembled on the shaft to be offset at about 90 degrees from a second pair of Cylindrical Containers.

3. The rotation generation device of claim 1, comprising a Braking Apparatus for applying braking pressure to reduce rotational speed of the Shaft,

4. The rotation generation device of claim 3, wherein each Braking Apparatus comprises: a Pedestal, a Ringed Rod, a Brake Pedal, a Brake Pad and a weight with a center hole that sits on the Ringed Rod.

5. The rotation generation device of claim 1, wherein the fluid is a liquid.

6. The rotation generation device of claim 1, wherein the length of the hollow tube equals: a length of one Chamber, plus a length of the tubular members interconnecting Chambers, plus a thickness of the Pistons.

7. The rotation generation device of claim 1, comprising a Shaft Assembly that enables rotation of the Cylindrical Containers and which is connected to a gearbox coupled to a generator for producing electricity, comprising:
Clamps with female sockets and Panels coupled together on either side, so as to hold the Cylindrical Containers perpendicular to the Shaft;
Shaft Bits with male heads that connect to Clamps with female sockets;
Shaft Enders with male heads, the Shaft Enders having Radial Bearing Rings at both ends and a larger diameter center Brake Drum with Horizontal Grooves, the Radial Bearing Rings held within Brackets that can be attached to and supported by Stands.

8. The rotation generation device of claim 1, wherein the Bellows prevent backflow of liquid to another Chamber of a Cylindrical Container.

9. The rotation generation device of claim 1, further comprising an arrangement of Cylindrical Containers in a series of pairs, wherein each pair of Cylindrical Container is clamped to the Shaft so as to be perpendicular to the Shaft Assembly and 45 degrees to another pair of Cylindrical Containers clamped on the Shaft.

10. The rotation generation device of claim 1, further comprising: Two pairs of Hollow Pipes angled inwards at ends and with screw caps at ends, for each pair of Cylindrical Containers; wherein each Hollow Pipe has one end connected to a Chamber Cap Nozzle of an Cylindrical Container and the other end connected to a Chamber Cap nozzle of an adjacent Cylindrical Container in the pair; the connected Pipes being in a square-like form wherein the pair of Hollow Pipes from a Chamber Cap's dual nozzles do not connect into the same Chamber Cap's dual nozzles of an adjacent Cylindrical Container in the pair.

11. The gravity powered device of claim 1, further comprising: A quantity of liquid, preferably water, positioned in an upper quadrant Chamber of a Cylindrical Container, that provides enough torque to operate a generator and wherein: the upper quadrant Chamber of the Cylindrical Container is the one initiating the direction of Shaft's spin.

12. A rotation generation device comprising:
at least two pair of Cylindrical Containers having Chambers therein at each end to receive and discharge a fluid, each pair of Cylindrical Containers interconnected via a tubular member and mounted essentially perpendicular to a Shaft;
Threaded Caps with dual nozzles that screw on to each Chamber at the end of the Cylindrical Containers;
two pair of Pistons, each pair of Pistons interconnected via a hollow tube, each pair of Pistons resides in a sliding relationship in a respective pair of Cylindrical Containers and wherein the hollow tube interconnecting the pair of Pistons resides in the tubular member of the respective pair of Cylindrical Containers, the hollow tubes having a length for a first of the pair of pistons to cause one of the Cylindrical Containers to receive fluid as the first piston slides within the respective Cylindrical Container, while a second of the pair pistons causes another of the Cylindrical Containers to discharge fluid therein,;
a weight, residing and capable of moving laterally within each of the hollow tubes;
Pipes interconnecting adjacent Cylindrical Containers via the Cap nozzles;
Bellows within each Chamber of the Cylindrical Containers, wherein each bellow attaches on one end to a Piston and at an opposite end to the Chamber of the Cylindrical Container to prevent backflow of fluid to another Chamber of a Cylindrical Container.

13. The rotation generation device of claim 12, wherein a first pair of Cylindrical Containers is assembled on the Shaft to be offset at about 90 degrees from a second pair of Cylindrical Containers.

14. The rotation generation device of claim 12, comprising a Braking Apparatus for applying braking pressure to reduce rotational speed of the Shaft,

15. The rotation generation device of claim 14, wherein each Braking Apparatus comprises: a Pedestal, a Ringed Rod, a Brake Pedal, a Brake Pad and a weight with a center hole that sits on the Ringed Rod.

16. The rotation generation device of claim 12, wherein the fluid is a liquid.

17. The rotation generation device of claim 12, wherein the length of each of the hollow tubes equals: a length of one Chamber, plus a length of the tubular members interconnecting Chambers, plus a thickness of the Pistons.

18. The rotation generation device of claim 12, further comprising an arrangement of Cylindrical Containers in a series of pairs, wherein each pair of Cylindrical Containers is clamped to the Shaft so as to be perpendicular to the Shaft Assembly and 45 degrees to another pair of Cylindrical Containers clamped on the Shaft.

19. The rotation generation device of claim 12, further comprising: Two pairs of Hollow Pipes angled inwards at ends and with screw caps at ends, for each pair of Cylindrical Containers; wherein each Hollow Pipe has one end connected to a Chamber Cap Nozzle of an Cylindrical Container and the other end connected to a Chamber Cap nozzle of an adjacent Cylindrical Container in the pair; the connected Pipes being in a square-like form wherein the pair of Hollow Pipes from a Chamber Cap's dual nozzles do not connect into the same Chamber Cap's dual nozzles of an adjacent Cylindrical Container in the pair.
